(19) United States
(12) Patent Application Publication
(10) Pub. No.: US 2019/0058843 A1
(43) Pub. Date: Feb. 21, 2019

(54) IMAGE PROCESSING DEVICE, IMAGE PROCESSING METHOD, CONTROL PROGRAM, AND RECORDING MEDIUM

(71) Applicant: SHARP KABUSHIKI KAISHA, Sakai City, Osaka (JP)

(72) Inventors: HIDEKI SUZUKI, Sakai City (JP); TOMOO NISHIGAKI, Sakai City (JP); RYOJI SAKURAI, Sakai City (JP); KAZUYOSHI YOSHIYAMA, Sakai City (JP); NAOAKI SHIBAMOTO, Sakai City (JP)

(21) Appl. No.: 16/079,500

(22) PCT Filed: Jun. 22, 2017
(86) PCT No.: PCT/JP2017/023094

§ 371 Date: Aug. 23, 2018

(30) Foreign Application Priority Data
Jul. 1, 2016 (JP) 2016-132056

(51) Int. Cl. H04N 5/57

(52) U.S. Cl. CPC H04N 5/57

(57) ABSTRACT

A technique for preventing a significant change of viewer's perception of brightness for each content. An image processing device (1) includes a calculation unit (6) configured to calculate a video feature from a parameter in a video signal for transmission and an adjustment unit (8) configured to adjust the parameter such that the video feature calculated by the calculation unit is approximated to a prescribed reference value.

### TECHNICAL FIELD

The present invention relates to an image processing device configured to adjust luminance values in a video signal.

### BACKGROUND ART

As an example of audio-related techniques, a technique is known which uniforms audience's perception of the level of a sound for each content based on loudness representing the level of a sound which a person perceives. Moreover, in video-related techniques, it becomes possible to display high-luminance video such as high dynamic range (HDR) video, which increases the number of cases where a viewer's perception of brightness significantly changes for each content.

### CITATION LIST

### Patent Literature

PTL 1: Japanese Unexamined Patent Application Publication No. 10-322622 (publication date: Dec. 4, 1998)

### SUMMARY OF INVENTION

### Technical Problem

When a viewer's perception of brightness significantly changes for each content, the psychological stress of the viewer may increase. For example, when the brightness of a program main part is normal brightness, and the brightness of a commercial inserted in the program main part is significantly higher than the brightness of the program main part, a viewer is surprised by the difference between the brightness of the program main part and the brightness of the commercial at the time when the program main part is switched to the commercial. In contrast, when the commercial is switched to the program main part, a viewer, after accustomed to the brightness of the commercial, watches the program main part. Therefore, the viewer has an impression that the program main part is very dark, and the viewer may not be able to concentrate on the program main part.

In view of the foregoing, it is an object of the present invention to provide a technique for preventing a significant change of brightness for each content.

### Solution to Problem

To solve the problems described above, an image processing device according to one aspect of the present invention includes a calculation unit configured to calculate a video feature from a parameter in a video signal for transmission, and an adjustment unit configured to adjust the parameter such that the video feature calculated by the calculation unit is approximated to a prescribed reference value.

To solve the problems described above, an image processing method according to one aspect of the present invention includes a calculation step of calculating a video feature from a parameter in a video signal for transmission, and an adjustment step of adjusting the parameter such that the video feature calculated in the calculation step is approximated to a prescribed reference value.

### Advantageous Effects of Invention

According to one aspect of the present invention, it is possible to prevent a significant change of viewer's perception of brightness for each content and to reduce unnecessary psychological stress of the viewer.

### BRIEF DESCRIPTION OF DRAWINGS

FIG. 1 is a block diagram illustrating a configuration of an image processing device according to a first embodiment of the present invention.

FIG. 2 is a flowchart illustrating an image processing method according to the first embodiment of the present invention.

FIG. 3 is a view illustrating a reference value in the first embodiment of the present invention.

FIG. 4 is a view illustrating a reference value in the first embodiment of the present invention.

FIG. 5 is a view illustrating a method for adjusting luminance values in the first embodiment of the present invention.

FIG. 6 is a flowchart illustrating an image processing method according to a second embodiment of the present invention.

FIG. 7 is a view illustrating a method for excluding luminance values larger than or equal to a prescribed value in a third embodiment of the present invention.

FIG. 8-1 shows a pseudocode for calculating a perceptual luminance value in a second aspect of the third embodiment of the present invention.

FIG. 8-2 shows a pseudocode for calculating the perceptual luminance value in the second aspect of the third embodiment of the present invention.

FIG. 9 is a pseudocode for calculating a MaxFALL.

### DESCRIPTION OF EMBODIMENTS

Embodiments of the present invention will be described in detail below. Note that configurations described in the embodiments are not to limit the scope of the present invention to only the illustrated configurations and are merely illustrative examples, unless otherwise specified.

In the embodiments below described is an example in which an average luminance value serving as an index of perceptual luminance values is adopted as a video feature.

### First Embodiment

### (Image Processing Device 1)

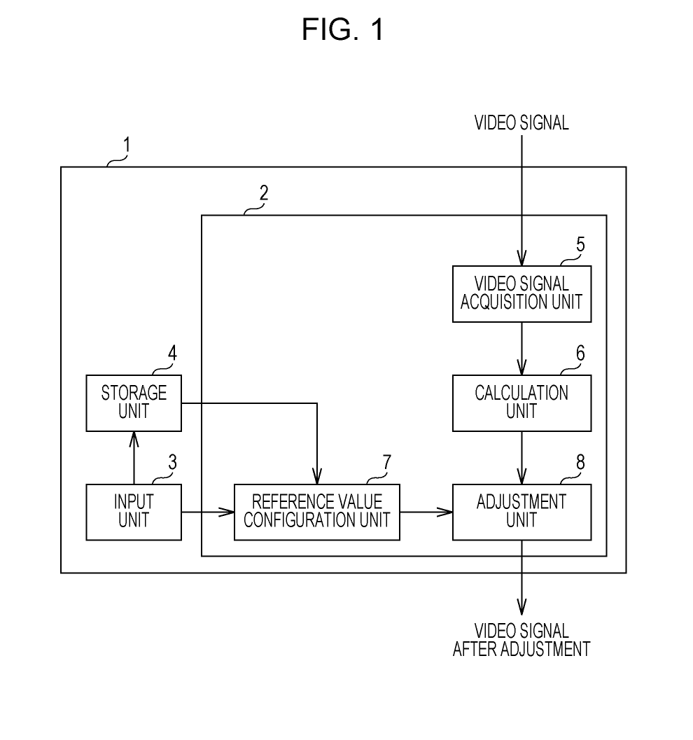

With reference to FIG. 1, an image processing device 1 according to a first embodiment of the present invention will be described. FIG. 1 is a block diagram illustrating a configuration of the image processing device 1 according to the present embodiment. As illustrated in FIG. 1, the image processing device 1 includes a processing unit 2, an input unit 3, and a storage unit 4.

The processing unit 2 includes a video signal acquisition unit 5, a calculation unit 6, a reference value configuration unit 7, and an adjustment unit 8. The video signal acquisition unit 5 acquires a video signal for transmission.

The calculation unit 6 calculates a video feature from a parameter in the video signal for transmission. More specifically, the calculation unit 6 calculates second average luminance values each serving as an average luminance value of a corresponding one of a plurality of frames included in the video signal for transmission acquired by the video signal acquisition unit 5 and averages the second average luminance values of the plurality of frames to calculate a first average luminance value.

The reference value configuration unit 7 acquires luminance values of various contents received by the input unit 3 or luminance values of various contents held in the storage unit 4 and configures a reference value with reference to the luminance values.

The adjustment unit 8 adjusts the parameter such that the video feature calculated by the calculation unit 6 is approximated to a prescribed reference value. More specifically, the adjustment unit 8 adjusts the luminance values in the video signal for transmission such that the first average luminance value calculated by the calculation unit 6 is approximated to the reference value configured by the reference value configuration unit 7.

The input unit 3 externally receives luminance values of various contents. The storage unit 4 stores the luminance values of the various contents received by the input unit 3.

Note that the video feature described-above corresponds to an index representing perceptual brightness of video. Examples of the video feature include a perceptual luminance value. The perceptual luminance value corresponds to an index calculated from luminance values in the video signal. Examples of the perceptual luminance value include an average luminance value, a maximum luminance value, a median value of luminance values, and a Maximum Frame Average Light Level (MaxFALL) as static metadata defined by the Blue-ray Disk Association (BDA). Note that the video feature includes not only the index, such as the perceptual luminance value, calculated from luminance values in the video signal but also an index calculated from chromaticities in the video signal. Moreover, the median value of luminance values may be any of an average median value obtained by averaging a median value of luminance values per frame over a plurality of frames and a median value of a histogram over a plurality of frames based on an average luminance value per frame, in other words, a median value of a histogram representing a change of an average luminance value over time.

### (Image Processing Method by Image Processing Device 1)

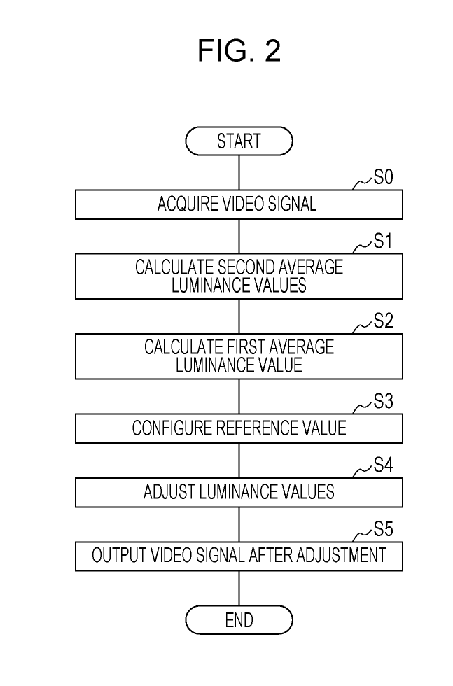

With reference to FIG. 2, an image processing method executed by the image processing device 1 according to the present embodiment will be described. FIG. 2 is a flowchart illustrating the image processing method.

First, the video signal acquisition unit 5 acquires a video signal for transmission (step S0). Here, the video signal for transmission can be an HDR video signal. Next, the calculation unit 6 calculates second average luminance values each serving as an average luminance value of a corresponding one of a plurality of frames included in the video signal for transmission acquired by the video signal acquisition unit 5 (step S1). The plurality of frames mentioned herein may be all frames included in the video signal for transmission or may be a plurality of frames of each scene included in the video signal for transmission. Subsequent to step S1, the calculation unit 6 averages the second average luminance values of the plurality of frames to calculate a first average luminance value (step S2).

Next, the reference value configuration unit 7 acquires luminance values of various contents via the input unit 3 or the storage unit 4 and configures a reference value with reference to the luminance values (step S3). Note that the reference value configuration unit 7 may directly acquire a reference value determined outside the image processing device 1.

Note that the order of step S3 in steps S0 to S3 is not limited to the order of steps shown in FIG. 2.

In a step following step S3, the adjustment unit 8 adjusts the luminance values in the video signal for transmission such that the first average luminance value calculated by the calculation unit 6 is approximated to the reference value configured by the reference value configuration unit 7 (step S4). Next, the adjustment unit 8 outputs the video signal for transmission with adjusted luminance values (step S5).

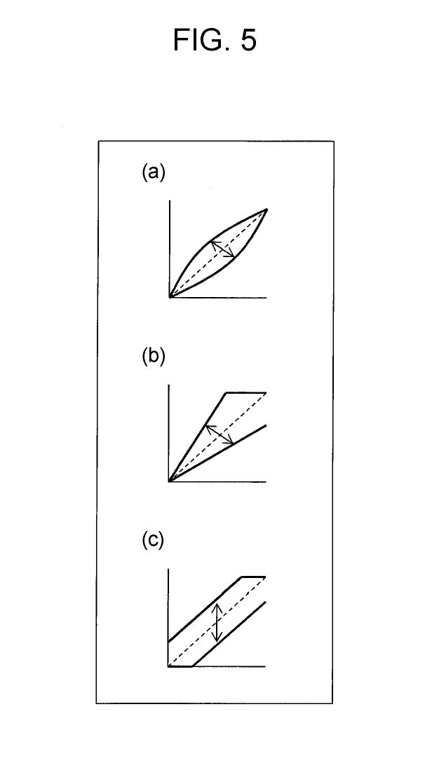

In step S4 described above, a method for adjusting the luminance values by the adjustment unit 8 may be any method, and an example of the method will be described below with reference to FIG. 5. FIGS. 5(a) to 5(c) are views illustrating an example of the method for adjusting the reference values. In each graph in FIGS. 5(a) to 5(c), the horizontal axis represents luminance values before adjustment in one frame of a video signal for transmission, and the vertical axis represents the luminance values after the adjustment in the frame. In the graph in FIG. 5(a), the origin of the luminance values and a maximum value of the luminance values are fixed, and a middle tone luminance value is adjusted through gamma adjustment, so that a gamma curve is applied to the luminance values before the adjustment and the luminance values after the adjustment. In the graph in FIG. 5(b), the origin of the luminance values is fixed, and the luminance values after the adjustment with respect to the luminance values before the adjustment are multiplied by a gain through gain adjustment (contrast control) to adjust the luminance values without collapse of low luminance. In the graph in FIG. 5(c), an offset adjustment block (black level adjustment) is adopted so as to add an offset to the luminance values after the adjustment with respect to the luminance values before the adjustment, thereby adjusting the luminance values without changing the gradation property of an intermediate luminance value. As illustrated in connection with the examples in FIGS. 5(a) to 5(c), the adjustment unit 8 adjusts the luminance values through gamma adjustment, gain adjustment, or offset adjustment so that the first average luminance value is approximated to the reference value. This enables the luminance values of contents to be adjusted without imparting sense of discomfort to a viewer.

### (Configuration Example of Reference Value)

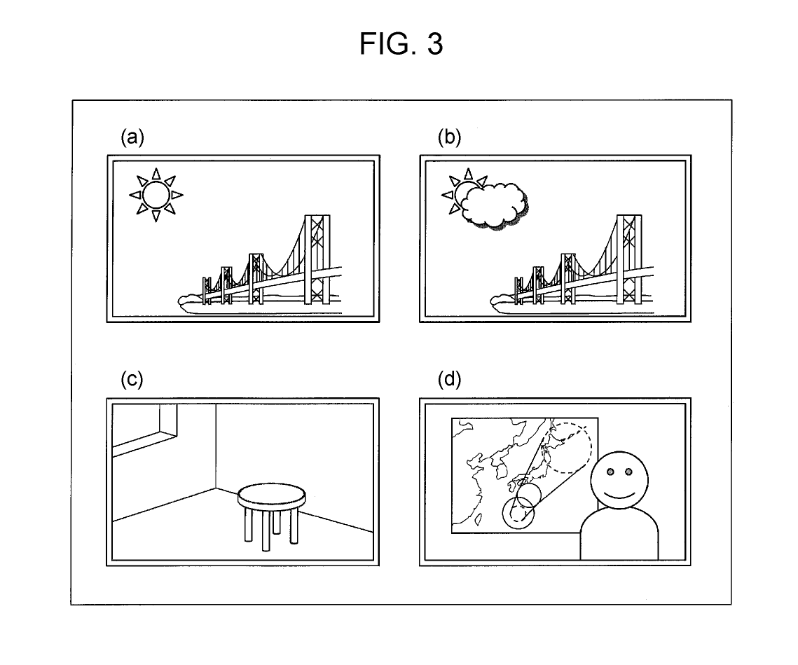

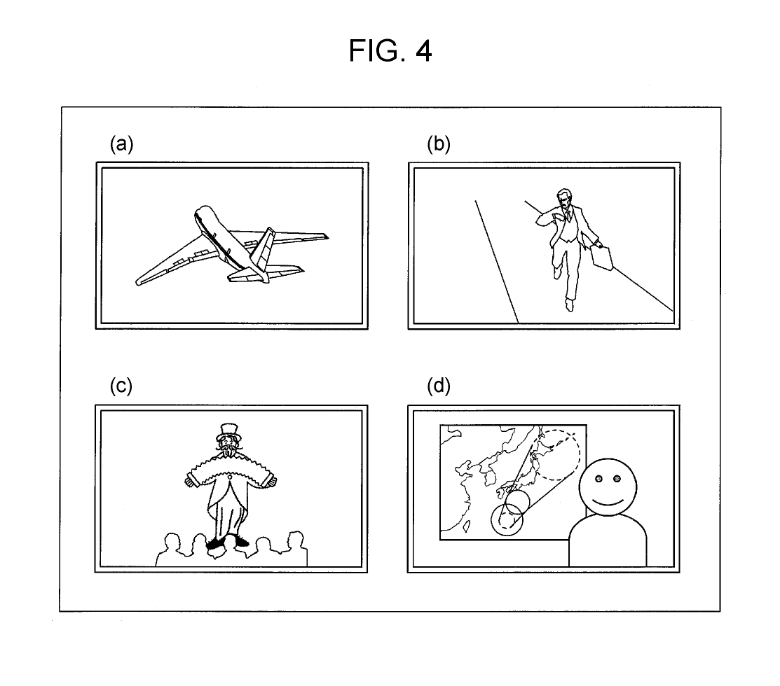

With reference to FIGS. 3 and 4, examples of the reference values in the present specification will be described below. FIGS. 3(a) to 3(b) are views each illustrating a method for configuring a reference value in accordance with capturing conditions at the time of capturing contents represented by a video signal for transmission. FIG. 3(a) shows a capturing target under capturing conditions that a capturing location is located outdoors and the weather is sunny. For a video signal for transmission representing contents under the capturing conditions, a reference value of 300 nit is configured. FIG. 3(b) shows a capturing target under capturing conditions that a capturing location is located outdoors and the weather is cloudy. For a video signal for transmission representing contents under the capturing conditions, a reference value of 200 nit is configured. FIG. 3(c) shows a capturing target under capturing conditions that a capturing location is located indoors. For a video signal for transmission representing contents under the capturing condition, a reference value of 100 nit is configured. FIG. 3(d) shows a capturing target under capturing conditions that a capturing location is located in a studio. For a video signal for transmission representing contents under the capturing condition, a reference value of 200 nit is configured. As the method for configuring a reference value according to capturing conditions by the reference value configuration unit 7, an arbitrary method can be used, and examples of the method include collecting still images representing contents under the same capturing condition and configuring a value obtained by averaging average luminance values of the still images as the reference value.

FIGS. 4(a) to 4(b) are views illustrating a method for configuring a reference value in accordance with the genre of contents represented by a video signal for transmission. FIG. 4(a) shows an example of contents whose genre corresponds to movies. For a video signal for transmission representing contents of the genre, a reference value of 200 nit or smaller is configured. FIG. 4(b) shows an example of contents whose genre corresponds to dramas. For a video signal for transmission representing contents of the genre, a reference value of 300 nit or smaller is configured. FIG. 4(c) shows an example of contents whose genre corresponds to variety shows. For a video signal for transmission representing contents of the genre, the reference value is set to 300 nit. FIG. 4(d) shows an example of contents whose genre corresponds to news. For a video signal for transmission representing contents of the genre, a reference value of 200 nit is configured. As the method for configuring a reference value according to a genre by the reference value configuration unit 7, an arbitrary method can be used, and examples of the method include collecting video signals representing contents belonging to the same genre, and configuring, as the reference value, a value by averaging average luminance values of respective frames in the video signals.

As described above, in the image processing device 1 according to the present embodiment, the reference value is configured as a value corresponding to capturing conditions at the time of capturing contents represented by the video signal for transmission or the genre of the contents represented by the video signal for transmission. Then, the luminance values in the video signal for transmission are adjusted such that the first average luminance value is approximated to the reference value, which enables a receiver which receives the video signal for transmission to express the contents at brightness suitable for the type of the contents.

### (Various Examples of Reference Value)

Moreover, as the reference value, a value based on a video feature of standard video used for system evaluation as standard video may be used. Here, “value based on a video feature of standard video” may be the value itself of the video feature of standard video or a value whose difference from the value of the video feature of standard video falls within a prescribed range. Here, as the prescribed range, for example, about 10% of the value of the video feature of standard video may be used, but this is not to limit the present embodiment. Moreover, examples of the standard video include standard video obtained from ITR or JEITA or test pattern used in test broadcast. A broadcaster creates contents with reference to the standard video, and therefore, the video feature of the standard video is preferable as the reference value.

Alternatively, the reference value can be a value obtained by averaging video features of many contents. In this case, extraordinary values of the video feature can be excluded, and thus, this case is preferable. In order to configure the reference value, video features of contents may randomly be summed, or a value according to capturing conditions at the time of capturing contents or the genre of contents may be defined as the reference value. When the reference value is configured for each capturing condition at the time of capturing contents, the capturing conditions are classified into the studio, the outdoors, the indoors, and the like, and for each capturing condition, a value obtained by averaging video features of the contents may be defined as the reference value.

Alternatively, the value of a video feature which does not render many people uncomfortable may be defined as the reference value. When the video feature is luminance, for example, the reference value may be configured as the highest luminance at which many people do not feel too bright.

Moreover, a commercial can be removed while video features of contents are averaged. Note that an example of the video feature is luminance.

### Summary of First Embodiment

As described above, the image processing device 1 according to the present embodiment calculates a first average luminance value (video feature) from luminance values (parameter) in a video signal for transmission and adjusts the luminance values in the video signal for transmission such that the first average luminance value (video feature) is approximated to a prescribed reference value. Thus, in a receiver which receives the video signal for transmission with adjusted luminance values, it is possible to prevent a significant change of brightness for each content and to reduce unnecessary psychological stress of a viewer.

### Second Embodiment

A second embodiment of the present invention will be described below. Note that in the present embodiment, the image processing device 1 described in the first embodiment can be used. Thus, the description of each member in the image processing device 1 is omitted.

Only steps S11, S12, and S14 in an image processing method of an image processing device 1 according to the present embodiment are different from the steps in the image processing method of the image processing device 1 according to the first embodiment. Thus, in the following description, detailed description of steps other than steps S11, S12, and S14 corresponding to steps S1, S2 and S4 of the image processing method according to the first embodiment will be omitted.

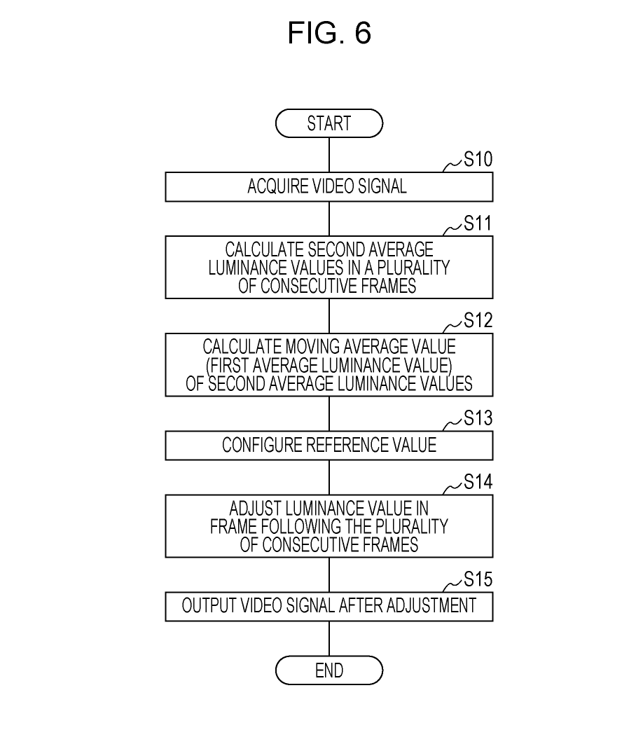

In the image processing method according to the present embodiment, a situation is estimated in which luminance values in a video signal for transmission acquired by capturing contents are successively adjusted. With reference to FIG. 6, the image processing method according to the present embodiment will be described. FIG. 6 is a flowchart illustrating the image processing method according to the present embodiment. First, a video signal acquisition unit 5 acquires a video signal for transmission (step S10). Next, a calculation unit 6 calculates second average luminance values each serving as an average luminance value of a corresponding one of a plurality of consecutive frames (step S11). The number of consecutive frames in this embodiment is an arbitrary number. For example, when immediately in response to the luminance values in the video signal for transmission acquired by the video signal acquisition unit 5, luminance values in a video signal for transmission subsequently acquired by the video signal acquisition unit 5 have to be adjusted, it is only required to reduce the number of frames which are referred to in order to calculate the second average luminance values.

Subsequent to step S11, the calculation unit 6 calculates a moving average value of the second average luminance values, thereby calculating a first average luminance value (step S12). Here, the number of second average movement values which are referred to in order to calculate the moving average value of the second average luminance values is an arbitrary number. For example, when immediately in response to the luminance values in the video signal for transmission acquired by the video signal acquisition unit 5, luminance values in a video signal for transmission subsequently acquired by the video signal acquisition unit 5 have to be adjusted, it is only required to reduce the number of the second average luminance values which are referred to in order to calculate the movable average value of the second average luminance values.

Subsequent to step S12, a reference value configuration unit 7 acquires luminance values of various contents via an input unit 3 or a storage unit 4 and configures a reference value with reference to the luminance values (step S13). The order of step S13 in steps S10 to S13 is not limited to the order of steps shown in FIG. 2. Next, an adjustment unit 8 adjusts luminance values in a frame following the plurality of consecutive frames, which are referred to in order to calculate the second average luminance values by the calculation unit 6, such that the first average luminance value calculated by the calculation unit 6 is approximated to the reference value (step S14). For example, when immediately in response to the luminance values in the video signal for transmission acquired by the video signal acquisition unit 5, luminance values in a video signal for transmission subsequently acquired by the video signal acquisition unit 5 have to be adjusted, the frame following the plurality of frames in this embodiment can be a frame immediately after the plurality of frames. Subsequent to step S14, the adjustment unit 8 outputs the video signal for transmission with adjusted luminance values (step S15).

As described above, the image processing device 1 according to the present embodiment calculates second average luminance values each serving as an average luminance value of a corresponding one of a plurality of consecutive frames and calculates a moving average of the second average luminance values to calculate a first average luminance value. Then, the image processing device 1 according to the present embodiment adjusts luminance values in a frame following the plurality of consecutive frames such that the first average luminance value is approximated to the reference value. Thus, in accordance with the luminance values in the consecutive frames, luminance values in frames following the frames can be successively adjusted.

### Third Embodiment

A third embodiment of the present invention will be described below. Note that in the present embodiment, the image processing device 1 described in the first embodiment can be used. Thus, the description of each member in the image processing device 1 is omitted.

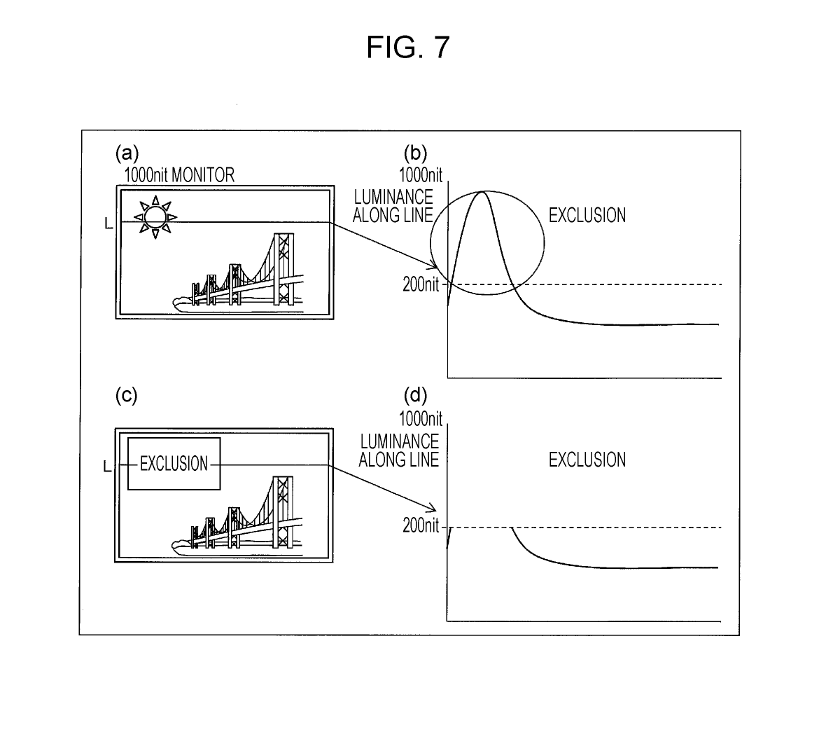

In step S1 and step S11 in the image processing method according to the first and second embodiments respectively, a calculation unit 6 calculates second average luminance values each serving as an average luminance value of a corresponding one of a plurality of frames included in a video signal for transmission. In the present embodiment, when the calculation unit 6 is to calculate a frame luminance value per frame, the calculation unit 6 excludes a region corresponding to luminance higher than or equal to a prescribed threshold value to calculate the frame luminance value. As an example, processes performed by the calculation unit 6 will be described with reference to FIG. 7, where the maximum luminance that is displayable on the display panel is 1000 nit, and the prescribed threshold value is 200 nit. FIGS. 7(a) to 7(d) are views illustrating a method for excluding luminance values larger than or equal to the prescribed value.

In the examples shown in FIGS. 7(a) and 7(b), the luminance along line L1 has luminance values larger than 200 nit. When the calculation unit 6 is to calculate the average of luminance values along the line L1 shown in FIG. 7(a), the calculation unit 6 calculates, for a high luminance region higher than or equal to 200 nit which is a prescribed luminance value, second average luminance values without using luminance values of the high luminance region.

More specifically, the calculation unit 6 defines a region including luminance values larger than or equal to a prescribed threshold value as an exclusion region as illustrated in FIG. 7(c), and the calculation unit 6 does not use the luminance in the exclusion region to calculate the second average luminance values as illustrated in FIG. 7(d). In other words, the calculation unit 6 refers to luminance values included in regions other than the exclusion region to calculate the second average luminance values.

As described above, the image processing device 1 according to the present embodiment calculates second average luminance values with luminance values larger than or equal to a prescribed value being excluded from luminance values in a plurality of frames. Thus, an average luminance value can be calculated without being influenced by significantly large luminance values.

### Fourth Embodiment

The present embodiment shows another example of the method for calculating second average luminance values with luminance values larger than or equal to a prescribed value being excluded from luminance values in a plurality of frames. In the present aspect, a calculation unit 6 excludes at least one of a black screen (screen with an average luminance lower than or equal to a threshold value Bk) and a white screen (screen with an average luminance higher than or equal to a threshold value Wt (Bk<Wt)) to calculate second average luminance values.

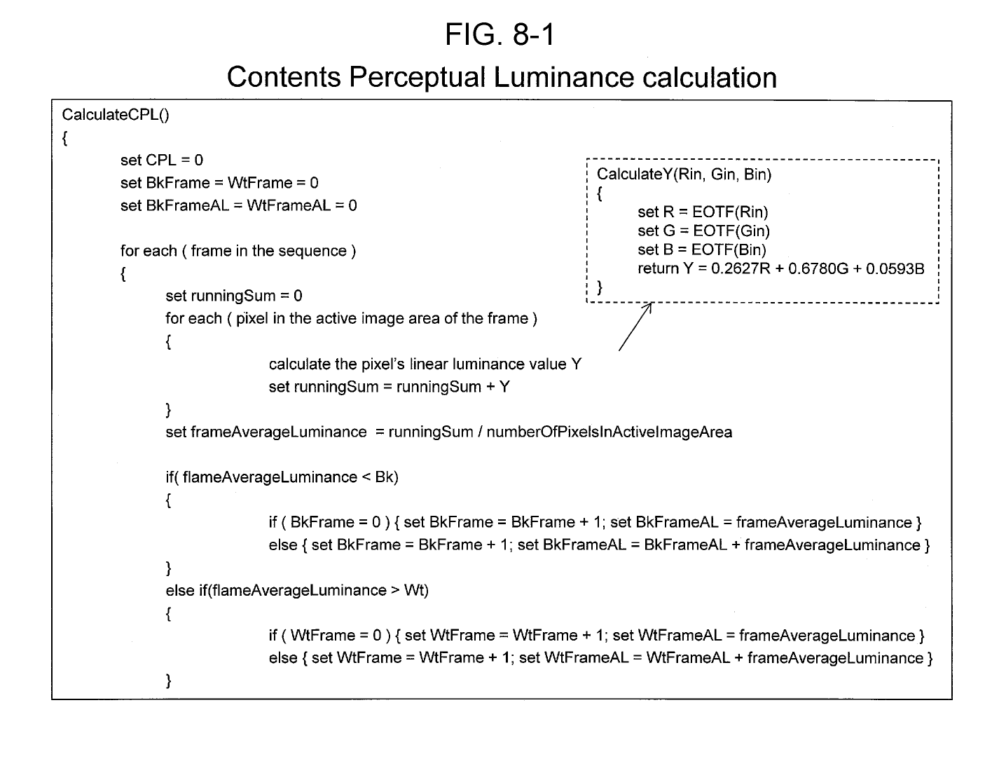

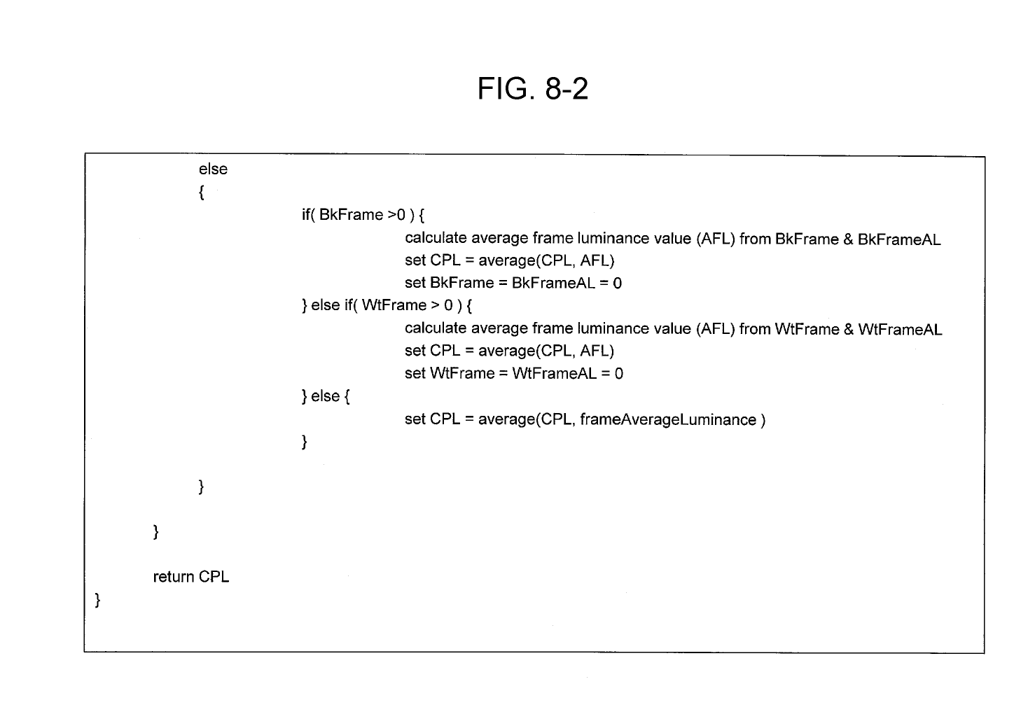

FIG. 8 shows a pseudocode for calculating a perceptual luminance value according to a second aspect of the present embodiment by the calculation unit 6. As illustrated in FIG. 8, the calculation unit 6 calculates, for each pixel included in an active image area in a frame, a linear luminance value Y of the pixel. Note that the active image area refers to, for example, a region obtained by excluding a region including luminance values larger than or equal to a prescribed luminance value from a frame as a target, but this should not be construed as limiting, and the active image data area can accordingly be configured. The linear luminance value Y is calculated based on the pseudocode shown in the dotted frame in FIG. 8. More specifically, the calculation unit 6 applies Electro-Optical Transfer Function (EOTF) conversion to pixel values (Rin, Gin, Bin) of the pixel to calculate luminance values (R, G, B) and further substitutes R, G, and B into the following formula to calculate the luminance value Y:

Y=0.2627R+0.6780G+0.0593B.

Then, the calculation unit 6 configures the average of luminance values Y of all pixels included in the active region as average luminance flameAverageLuminance as shown in FIG. 8.

Moreover, the calculation unit 6 excludes, as illustrated in FIG. 8, at least one of a black screen (screen with an average luminance lower than or equal to a threshold value Bk) and a white screen (screen with an average luminance higher than or equal to a threshold value Wt (Bk<Wt)) of all the frames included in a video sequence to average average luminances flameAverageLuminance, thereby calculating a perceptual luminance value of video as a target. Note that specific values of the threshold values Bk (first threshold value) and Wt (second threshold value) are not to limit the present embodiment, and, for example, Bk=50, Wt=2000.

As described above, an image processing device 1 according to the present embodiment calculates, in a manner similar to the image processing device 1 according to the third embodiment, second average luminance values with luminance values larger than or equal to a prescribed value being excluded from luminance values in a plurality of frames. Thus, an average luminance value can be calculated without being influenced by significantly large luminance values.

### Fifth Embodiment

In the first to fourth embodiments, the perceptual luminance value is the first average luminance value, and the image processing device 1 calculates the first average luminance value and adjusts the luminance values in the video signal for transmission such that the first average luminance value is approximated to the reference value. However, the perceptual luminance value may be a maximum frame average luminance (hereinafter referred to as MaxFALL), and the image processing device 1 may calculate the MaxFALL and adjust luminance values in a video signal for transmission such that the MaxFALL is approximated to a reference value. In the following description, the MaxFALL will be described in detail.

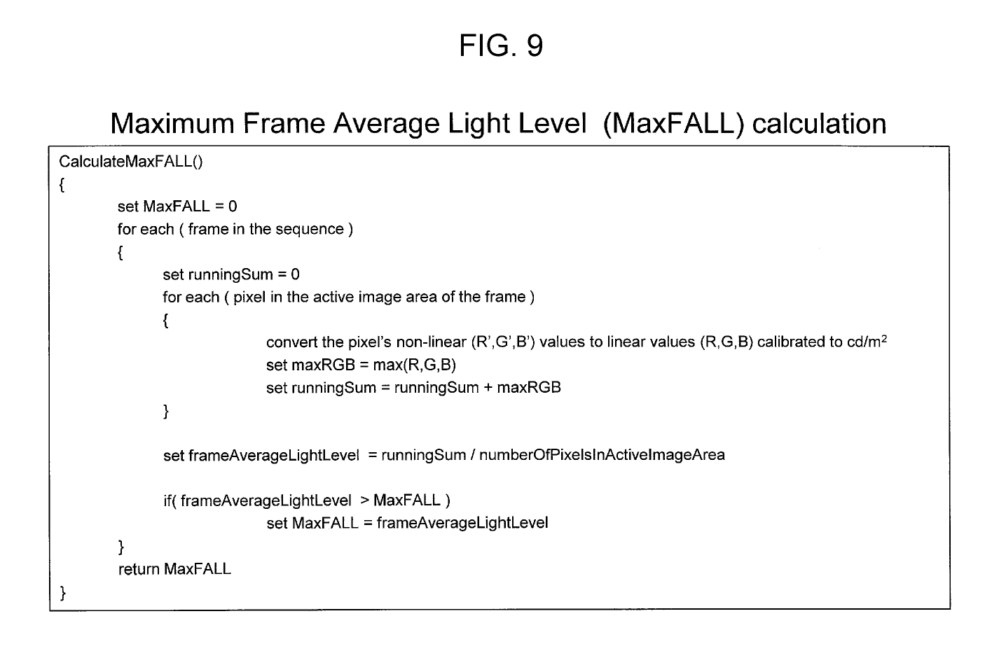

The MaxFALL is a maximum value of average luminances in all frames constituting video. FIG. 9 shows a pseudocode for calculating the MaxFALL by a calculation unit 6. As illustrated in FIG. 9, the calculation unit 6 converts non-linear pixel values (R′, G′, B′) into linear luminance values (R, G, B) in the unit of cd/m² (candela per square meter) for each pixel included in an active image area in a frame. Then, the calculation unit 6 configures a maximum value of (R, G, B) as a maximum luminance value (maxRGB) in the pixel.

Then, the calculation unit 6 configures the average of maximum luminance values maxRGB of all pixels included in the active region as an average luminance value (flameAverageLightLevel) in the frame.

Moreover, the calculation unit 6 configures the maximum average luminance value of average luminance values of all the frames included in the video sequence as the MaxFALL and configures the MaxFALL as the perceptual luminance value of video as a target.

Then, an adjustment unit 8 adjusts the luminance values in the video signal for transmission such that the MaxFALL calculated by the calculation unit 6 is approximated to a prescribed reference value.

### [Example Realized by Software]

Control blocks (in particular, the video signal acquisition unit 5, the calculation unit 6, the reference value configuration unit 7, and the adjustment unit 8 in the processing unit 2) of the image processing device 1 may be realized by logic circuits (hardware) formed in an integrated circuit (IC chip) or the like or realized by software by using a Central Processing Unit (CPU).

In the latter case, the image processing apparatus 1 includes, for example, a CPU which executes a command of a program as software for realizing various functions, Read Only Memory (ROM) or a storage device (which is referred to as “storage medium”) in which the program and various types of data are stored in a computer (or the CPU) readable manner, and Random Access Memory (RAM) into which the program is to be loaded. The computer (or the CPU) reads the program from the storage medium and executes the program to achieve the object of the present invention. As the storage medium, a “non-transitory tangible medium”, for example, a tape, disk, card, semiconductor memory, or programmable logic circuit may be used. Alternatively, the program may be supplied to the computer via any transmission medium (for example, a communication network or a broadcast wave) which can transmit the program. Note that the present invention may be realized in a form of a data signal which is realized by electronical transmission of the program and which is embedded in a carrier wave.

### [Supplementary Information]

In the specification, “calculation” includes meanings of deriving, computation, arithmetic, induction, and the like.

Moreover, in the specification, “adjustment” includes meanings of correction, modulation, accommodation, modification, setting, and the like.

Furthermore, in the specification, “perceptual luminance value” includes meanings of visual luminance, visual correction luminance, sensitivity luminance, sensory luminance, and the like.

### [Summary]

An image processing device (1) according to a first aspect of the present invention includes a calculation unit (6) configured to calculate a video feature from a parameter in a video signal for transmission and an adjustment unit (8) configured to adjust the parameter such that the video feature calculated by the calculation unit is approximated to a prescribed reference value.

With this configuration, in a receiver which receives the video signal for transmission with adjusted luminance values, it is possible to prevent a significant change of brightness for each content and to reduce unnecessary psychological stress of a viewer.

In an image processing device (1) according to a second aspect of the present invention referring to the first aspect, the parameter includes luminance values, and the video feature is a perceptual luminance value.

This configuration provides an effect similar to that provided by the image processing device according to the first aspect.

In an image processing device (1) according to a third aspect of the present invention referring to the second aspect, the calculation unit calculates the perceptual luminance value with reference to at least any of an average luminance value of the video signal for transmission, a maximum luminance value, a median value of luminance values, and a MAXFALL.

This configuration provides an effect similar to that provided by the image processing device according to the second aspect.

In an image processing device (1) according to a fourth aspect of the present invention, the calculation unit excludes at least one of a screen whose average luminance value is smaller than or equal to a first threshold value and a screen whose average luminance value is larger than or equal to a second threshold value from displayed video represented by the video signal for transmission to calculate the perceptual luminance value.

In an image processing device (1) according to a fifth aspect of the present invention referring to the second to fourth aspects, the perceptual luminance value is a first average luminance value.

With this configuration, the image processing device according to the second to fourth aspects can be appropriately used.

In an image processing device (1) according to a sixth aspect of the present invention referring to the fifth aspect, the calculation unit calculates second average luminance values each serving as an average luminance value of a corresponding one of a plurality of frames included in the video signal for transmission and averages the second average luminance values of the plurality of frames to calculate the first average luminance value.

With this configuration, a first average luminance value in accordance with the average luminance values of the frames included in the video signal for transmission is calculated, and the luminance values are adjusted such that the first average luminance value is approximated to the prescribed reference value. Thus, the luminance values can be adjusted in accordance with the average luminance values of the frames.

In an image processing device (1) according to a seventh aspect of the present invention referring to the fifth aspect, the calculation unit calculates second average luminance values each serving as an average luminance value of a corresponding one of a plurality of consecutive frames and calculates a moving average of the second average luminance values to calculate the first average luminance value, and the adjustment unit adjusts a luminance value in a frame following the plurality of consecutive frames such that the first average luminance value calculated by the calculation unit is approximated to the prescribed reference value.

With this configuration, in accordance with the luminance values in the consecutive frames, luminance values in frames following the frames can be successively adjusted.

In an image processing device (1) according to an eighth aspect of the present invention referring to the sixth or seventh aspect, the calculation unit calculates the second average luminance values with luminance values larger than or equal to a prescribed value being excluded from luminance values in the plurality of frames.

With this configuration, an average luminance value can be calculated without being influenced by significantly large luminance values, and the luminance values are adjusted such that the average luminance value is approximated to the prescribed reference value. Thus, the luminance values can be adjusted without being influenced by significantly large luminance values.

In an image processing device (1) according to a ninth aspect of the present invention referring to the fifth to eighth aspects, the adjustment unit adjusts the luminance values by at least one of gamma adjustment, gain adjustment, and offset adjustment such that the first average luminance value calculated by the calculation unit is approximated to the prescribed reference value.

With this configuration, the luminance values of contents can be adjusted without imparting sense of discomfort to a viewer.

An image processing device (1) according to a tenth aspect of the present invention referring to the first to ninth aspects further includes a reference value configuration unit (7) configured to configure the prescribed reference value as a value corresponding to a capturing condition when contents indicated by the video signal for transmission are captured or the genre of contents indicated by the video signal for transmission.

With this configuration, the luminance values in the video signal for transmission are adjusted such that the video feature is approximated to the reference value which is configured, which enables a receiver which receives the video signal for transmission to express the contents at brightness suitable for the type of the contents.

In an image processing device (1) according to an eleventh aspect of the present invention referring to the first to tenth aspects, the prescribed reference value is a value based on a video feature of standard video.

With this configuration, the image processing device according to the first to tenth aspects can be appropriately used.

An image processing method according to a twelfth aspect of the present invention includes a calculation step of calculating a video feature from a parameter in a video signal for transmission, and an adjustment step of adjusting the parameter such that the video feature calculated in the calculation step is approximated to a prescribed reference value.

This configuration provides an effect similar to that provided by the image processing device according to the first aspect.

An image processing device (1) according to a fourteenth aspect of the present invention adjusts the parameter such that the video feature according to the parameter in the video signal for transmission is approximated to the prescribed reference value.

This configuration provides an effect similar to that provided by the image processing device according to the first aspect.

In an image processing device (1) according to a fifteenth aspect of the present invention referring to the fourteenth aspect, the parameter includes luminance values, and the video feature is a perceptual luminance value.

This configuration provides an effect similar to that provided by the image processing device according to the second aspect.

An image processing device (1) according to a sixteenth aspect of the present invention referring to the fifteenth aspect calculates the perceptual luminance value with reference to at least any of an average luminance value of the video signal for transmission, a maximum luminance value, a median value of luminance values, and a MAXFALL.

This configuration provides an effect similar to that provided by the image processing device according to the third aspect.

An image processing device (1) according to a seventeenth aspect of the present invention referring to the fifteenth or sixteenth aspect excludes at least one of a screen whose average luminance value is smaller than or equal to a first threshold value and a screen whose average luminance value is larger than or equal to a second threshold value from displayed video represented by the video signal for transmission to calculate the perceptual luminance value.

This configuration provides an effect similar to that provided by the image processing device according to the fourth aspect.

An image processing device (1) according to an eighteenth aspect of the present invention referring to the fifteenth to seventeenth aspects is the image processing device according to any one of claims 15 to 17, wherein the perceptual luminance value is a first average luminance value.

This configuration provides an effect similar to that provided by the image processing device according to the fifth aspect.

An image processing device (1) according to a nineteenth aspect of the present invention referring to the eighteenth aspect calculates second average luminance values each serving as an average luminance value of a corresponding one of a plurality of frames included in the video signal for transmission and averages the second average luminance values of the plurality of frames to calculate the first average luminance value.

This configuration provides an effect similar to that provided by the image processing device according to the sixth aspect.

An image processing device (1) according to a twentieth aspect of the present invention referring to the eighteenth aspect calculates second average luminance values each serving as an average luminance value of a corresponding one of a plurality of consecutive frames and calculates a moving average of the second average luminance values to calculate the first average luminance value and adjusts a luminance value in a frame following the plurality of consecutive frames such that the first average luminance value which is calculated is approximated to the prescribed reference value.

This configuration provides an effect similar to that provided by the image processing device according to the seventh aspect.

An image processing device (1) according to a twenty-first aspect of the present invention referring to the nineteenth or twentieth aspect calculates second average luminance values with luminance values larger than or equal to a prescribed value being excluded from luminance values in a plurality of frames.

This configuration provides an effect similar to that provided by the image processing device according to the eighth aspect.

An image processing device (1) according to a twenty-second aspect of the present invention referring to the eighteenth to twenty-first aspects adjusts the luminance values by at least one of gamma adjustment, gain adjustment, and offset adjustment such that the first average luminance value which is calculated is approximated to the prescribed reference value.

This configuration provides an effect similar to that provided by the image processing device according to the ninth aspect.

An image processing device (1) according to a twenty-third aspect of the present invention referring to the fourteen to twenty-second aspects is configured to configure the prescribed reference value as a value corresponding to a capturing condition at a time of capturing contents represented by the video signal for transmission or a genre of the contents represented by the video signal for transmission.

This configuration provides an effect similar to that provided by the image processing device according to the tenth aspect.

The image processing device according to each aspect of the present invention may be realized by a computer. In this case, the scope of the present invention includes an image processing device control program of the image processing device which causes a computer to operate as each component (software elements) included in the image processing device to realize the image processing device by the computer, and a computer-readable recording medium which stores the control program.

The present invention is not limited to the embodiments described above. Various modifications may be made within the scope of the claims. Embodiments obtained by accordingly combining the techniques disclosed in different embodiments are also within the technical scope of the present invention. Moreover, combining technical means disclosed in the embodiments can provide new technical feature.

### REFERENCE SIGNS LIST

1 IMAGE PROCESSING DEVICE

2 PROCESSING UNIT

3 INPUT UNIT

4 STORAGE UNIT

5 VIDEO SIGNAL ACQUISITION UNIT

6 CALCULATION UNIT

7 REFERENCE VALUE CONFIGURATION UNIT

8 ADJUSTMENT UNIT

1. An image processing device comprising:
a calculation unit configured to calculate a video feature from a parameter in a video signal for transmission; and
an adjustment unit configured to adjust the parameter such that the video feature calculated by the calculation unit is approximated to a prescribed reference value.

2. The image processing device according to claim 1, wherein
the parameter includes luminance values, and
the video feature is a perceptual luminance value.

3. The image processing device according to claim 2, wherein
the calculation unit calculates the perceptual luminance value with reference to at least any of an average luminance value of the video signal for transmission, a maximum luminance value, a median value of luminance values, and a MAXFALL.

4. The image processing device according to claim 2, wherein
the calculation unit excludes at least one of
a screen whose average luminance value is smaller than or equal to a first threshold value and
a screen whose average luminance value is larger than or equal to a second threshold value
from displayed video represented by the video signal for transmission to calculate the perceptual luminance value.

5. The image processing device according to claim 2, wherein
the perceptual luminance value is a first average luminance value.

6. The image processing device according to claim 5, wherein
the calculation unit calculates second average luminance values each serving as an average luminance value of a corresponding one of a plurality of frames included in the video signal for transmission and averages the second average luminance values of the plurality of frames to calculate the first average luminance value.

7. The image processing device according to claim 5, wherein
the calculation unit calculates second average luminance values each serving as an average luminance value of a corresponding one of a plurality of consecutive frames and calculates a moving average of the second average luminance values to calculate the first average luminance value, and
the adjustment unit adjusts a luminance value in a frame following the plurality of consecutive frames such that the first average luminance value calculated by the calculation unit is approximated to the prescribed reference value.

8. The image processing device according to claim 6, wherein
the calculation unit calculates the second average luminance values with luminance values larger than or equal to a prescribed value being excluded from luminance values in the plurality of frames.

9. The image processing device according to claim 5, wherein
the adjustment unit adjusts the luminance values by at least one of gamma adjustment, gain adjustment, and offset adjustment such that the first average luminance value calculated by the calculation unit is approximated to the prescribed reference value.

10. The image processing device according to claim 1, further comprising:
a reference value configuration unit configured to configure the prescribed reference value as a value corresponding to a capturing condition at a time of capturing contents represented by the video signal for transmission or a genre of the contents represented by the video signal for transmission.

11. The image processing device according to claim 1, wherein
the prescribed reference value is a value based on a video feature of standard video.

12. An image processing method comprising:
a calculation step of calculating a video feature from a parameter in a video signal for transmission, and
an adjustment step of adjusting the parameter such that the video feature calculated in the calculation step is approximated to a prescribed reference value.

13. (canceled)

14. A computer-readable recording medium storing the control program that causes a computer to function as the image processing device according to claim 1.
